(19) United States
(12) Patent Application Publication
(10) Pub. No.: US 2006/0292272 A1
(43) Pub. Date: Dec. 28, 2006

(54) Method for producing a carbon monoxide-treated comminuted meat product

(75) Inventor: Eldon Roth, Dakota Dunes, SD (US)

Correspondence Address: THE CULBERTSON GROUP, P.C., 1114 LOST CREEK BLVD., SUITE 420, AUSTIN, TX, 78746, US

(73) Assignee: Freezing Machines, Inc.

(21) Appl. No.: 11/510,418

(22) Filed: Aug. 25, 2006

Related U.S. Application Data
(63) Continuation-in-part of application No. 11/502,841, filed on Aug. 11, 2006.
Application No. 11/502,841 is a continuation of application No. 10/795,000, filed on Mar. 5, 2004, now Pat. No. 7,094,435.
(60) Provisional application No. 60/736,631, filed on Nov. 15, 2005.

(51) Int. Cl. A23L 1/27

(52) U.S. Cl. 426/263

(57) ABSTRACT

A method includes applying a treatment material containing carbon monoxide to an initial meat product to produce an intermediate meat product. Once the treatment material containing carbon monoxide is applied to the initial meat product to produce the intermediate product, the intermediate meat product is comminuted to produce a final comminuted meat product. The method may further include applying a pH modifying material to the initial meat product or intermediate meat product. The pH modifying material may be applied as either a pre-treatment before applying the carbon monoxide-bearing treatment material, as part of the treatment material containing carbon monoxide, or as a post-treatment after applying the treatment material containing carbon monoxide. A pH modifying material applied to the meat product may include ammonia-based pH modifying materials such as ammonia gas and ammonium hydroxide solution, and carbon dioxide-based pH modifying materials such as carbon dioxide gas and carbonic acid solutions.

### CROSS-REFERENCE TO RELATED APPLICATIONS

This application is a continuation-in-part of U.S. patent application Ser. No. 11/502,841, filed Aug. 11, 2006, and entitled “Method for Treating Meat Products With Carbon Monoxide,” which is a continuation of U.S. patent application Ser. No. 10/795,000, filed Mar. 5, 2004, and entitled “Method and Apparatus for Treating Meat Products With Carbon Monoxide.” The benefit of these prior applications is hereby claimed in the present application pursuant to 35 U.S.C. §120. This application also claims the benefit under 35 U.S.C. §119(e) of U.S. Provisional Patent Application Ser. No. 60/736,631, filed Nov. 15, 2005, and entitled “Method and Apparatus for Treating Meat Products With a Treatment Liquid Containing Carbon Monoxide.” The entire content of each of these prior applications is incorporated herein by this reference.

### TECHNICAL FIELD OF THE INVENTION

This invention relates to meat processing operations and equipment. More particularly, the invention relates to methods and apparatus for producing a carbon monoxide treated comminuted meat product.

### BACKGROUND OF THE INVENTION

It has long been known that carbon monoxide may be used to produce a bright red color in a meat product. U.S. Pat. No. 4,522,835 to Woodruff et al. discloses a process of treating meat products with carbon monoxide gas to modify the color at the surface of the meat product.

It has also been proposed to use carbon monoxide gas as a preservative in meat products. U.S. Pat. No. 6,270,829 to Shaklai discloses a process where raw meat is exposed to carbon monoxide gas for a sufficient period to saturate the meat with carbon monoxide to inhibit microbial activity in the meat product. The Shaklai patent also discloses that the carbon monoxide saturation in the meat product produces a color change throughout the meat product.

Carbon monoxide gas has also been used in an injection material to treat meat products. U.S. Pat. No. 3,119,696 to Williams discloses injecting meat with a water and gas combination for the purpose of improving the tenderness of the meat. The Williams patent discloses that the gas is included in the water/gas treatment material to help facilitate absorption of the water fraction into the meat. The Williams patent also discloses that carbon monoxide may be included in the gas portion of the water/gas combination in order to modify the color of the meat in the interior of the meat product.

The change in color from carbon monoxide treatment results from the reaction of carbon monoxide with hemoglobin and myoglobin in meat products to form carboxyhemoglobin and carboxymyoglobin respectively. The microbial activity inhibiting effect of carbon monoxide in meat products is at least in part produced by reducing the oxygen content in the meat product. This reduction in oxygen content creates an unsuitable environment for aerobic microbes. Carbon monoxide treatment may also inhibit the growth and propagation of anaerobic microbes as well.

Despite the benefits, there remain certain problems associated with treating meat products with carbon monoxide. One problem with treating uncooked meats with carbon monoxide is that the treatment may affect the color of the product after the meat begins to spoil and after cooking. In particular, prior art carbon monoxide treatments may produce a bright red color that persists in the uncooked meat even after the meat begins to spoil due to microbial activity in the meat. Thus, prior art carbon monoxide treatments may mask spoilage in a meat product. Also, prior art carbon monoxide treatments may leave the uncooked meat with a bright red color that remains in the meat even after the meat is cooked. This unnatural red color in the cooked meat product occurs throughout the product where the entire product is saturated with carbon monoxide. Even where only the surface of the meat product is saturated with carbon monoxide, the surface of the cooked meat product may have an unnatural red color and the meat may not brown properly. Thus, although the carbon monoxide treated, uncooked meat product may have an appearance that is desirable to consumers, the color in the uncooked meat product may mask spoilage and the color remaining in the cooked meat product may be unacceptable to consumers.

### SUMMARY OF THE INVENTION

The present invention provides methods for producing a carbon monoxide-treated comminuted meat product while reducing or eliminating the problems associated with spoilage masking and unnatural color in the uncooked and cooked meat products. It is noted that the term “meat product” is used here and throughout this disclosure and the accompanying claims to refer to meat alone, including lean portions, fat, and related materials of beef, pork, poultry, or seafood, and to refer to meat that has been mixed with, or includes, additives such as flavorings, extenders, tenderizing agents, and other materials.

One preferred method embodying the principles of the invention includes applying a treatment material containing carbon monoxide to an initial meat product to produce an intermediate meat product. Once the treatment material containing carbon monoxide is applied to the initial meat product to produce the intermediate product, the intermediate meat product is comminuted to produce a final comminuted meat product.

The treatment material containing carbon monoxide may be any liquid or gaseous material containing carbon monoxide either in gaseous form or in solution in a carrier liquid. A treatment material containing carbon monoxide within the scope of the invention may include any suitable material in addition to carbon monoxide, and any additional materials may be in gaseous or liquid form. One preferred treatment material containing carbon monoxide comprises a suitable carrier liquid having carbon monoxide in solution. More particularly, one preferred treatment material containing carbon monoxide comprises a solution of water and carbon monoxide.

Some preferred methods according to the present invention further include applying a pH modifying material to the initial meat product or intermediate meat product. The pH modifying material may be applied as either a pre-treatment before applying the carbon monoxide-bearing treatment material, as part of the treatment material containing carbon monoxide, or as a post-treatment after applying the treatment material containing carbon monoxide. Preferred pH modifying materials include ammonia-based pH modifying materials such as ammonia gas and ammonium hydroxide solution, and carbon dioxide-based pH modifying materials such as carbon dioxide gas and carbonic acid solutions.

The initial meat product to which the present invention is applied may be whole animal carcasses or whole portions of an animal carcass such as a half or quarter. An initial meat product within the scope of the invention may also comprise a more highly processed meat such as bone-in or boneless cuts of meat such as bone-in or boneless steaks or roasts, or filets.

The designation “intermediate meat product” is used in this disclosure and the accompanying claims as simply one way to refer to meat products to which the treatment material containing carbon monoxide has been applied, as distinguished from meat that has not yet received any carbon monoxide treatment. Also, the terms “apply” and “applied” when used in connection with a treatment with any treatment material are intended to encompass any manner in which the particular treatment material may be applied. For example, a treatment material may be applied according to the invention by placing the treatment material in contact with a surface of the meat product to be treated or by injecting the treatment below the surface of a meat product via an injection conduit. Treatment materials may also be applied by surface application and by injection concurrently, or as discrete steps.

The comminution of the intermediate meat product may be accomplished in any suitable fashion within the scope of the present invention, either in a single comminution step or as multiple distinct steps. For example, where the initial meat product is a whole carcass or a half or quarter, the comminution may include first conducting trimming operations and then deboning, and then the trimmings or deboned meat, or both, may be further comminuted using a suitable comminuting device such as a meat grinder or bowl chopper. As another example, where the initial meat product has already been deboned, the intermediate meat product produced by the application of treatment material containing carbon monoxide may simply be comminuted by passing the intermediate meat product through a grinder or chopping the intermediate meat product in a bowl chopper. Regardless of the manner in which the intermediate meat product is comminuted, the comminution preferably produces a product made up primarily of meat product pieces measuring less than approximately two inches along their longest side, that is, having a major dimension of less than approximately two inches.

Treatments according to the present invention preferably result in a comminuted meat product having a carbon monoxide saturation of less than complete, that is, less than 100% saturation. As used in this document, complete or 100% carbon monoxide saturation in a meat product refers the case where all of the available hemoglobin and myoglobin in the meat product has been reacted with carbon monoxide to produce carboxyhemoglobin and carboxymyoglobin respectively. It will be noted that this does not necessarily mean that all hemoglobin and all myoglobin has been reacted since some hemoglobin and myoglobin in a meat product may reside in a state in which the reaction with carbon monoxide may not occur and may thus not be available to react with the carbon monoxide. Carbon monoxide saturation levels less than complete saturation may be described in this disclosure and the following claims as a percentage relative to complete saturation. For example, as used in this disclosure and the accompanying claims, 50% carbon monoxide saturation means that one-half of the available hemoglobin and myoglobin in the meat product has been converted to carboxyhemoglobin and carboxymyoglobin, respectively.

Carbon monoxide treatment according to the invention is particularly beneficial when combined with pH modifying treatments because it believed that the carbon monoxide affects the manner in which pH modifying materials are absorbed into the meat products. In particular, it is believed that the carboxy forms of hemoglobin and myoglobin formed from carbon monoxide treatment do not allow certain constituents in the pH modifying material to be absorbed with the hemoglobin and myoglobin. These constituents of the pH modifying material are beneficially absorbed elsewhere in the meat product. It is also believed that when pH modifying material is used together with carbon monoxide, the pH modifying material may help reduce the effect of the carbon monoxide on the color of the meat product and/or help make the color change less permanent. Thus, carbon monoxide treatments according to the present invention may produce the desired microbe inhibiting effect without unduly maintaining the red color in the treated product which might mask spoilage or affect the appearance of the cooked product.

These and other advantages and features of the invention will be apparent from the following description of the preferred embodiments, considered along with the accompanying drawings.

### BRIEF DESCRIPTION OF THE DRAWINGS

FIG. 1 is a block diagram illustrating the steps in one preferred treatment method embodying the principles of the present invention.

FIG. 2 is a diagrammatic representation of a system for treating meat products with carbon monoxide according to one preferred form of the present invention.

FIG. 3 is a diagrammatic representation of an injection system that may be used in the treatment system shown in FIG. 2.

### DESCRIPTION OF PREFERRED EMBODIMENTS

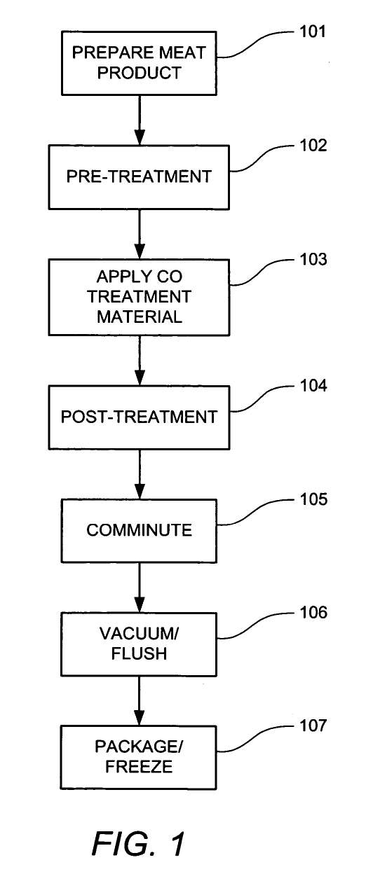

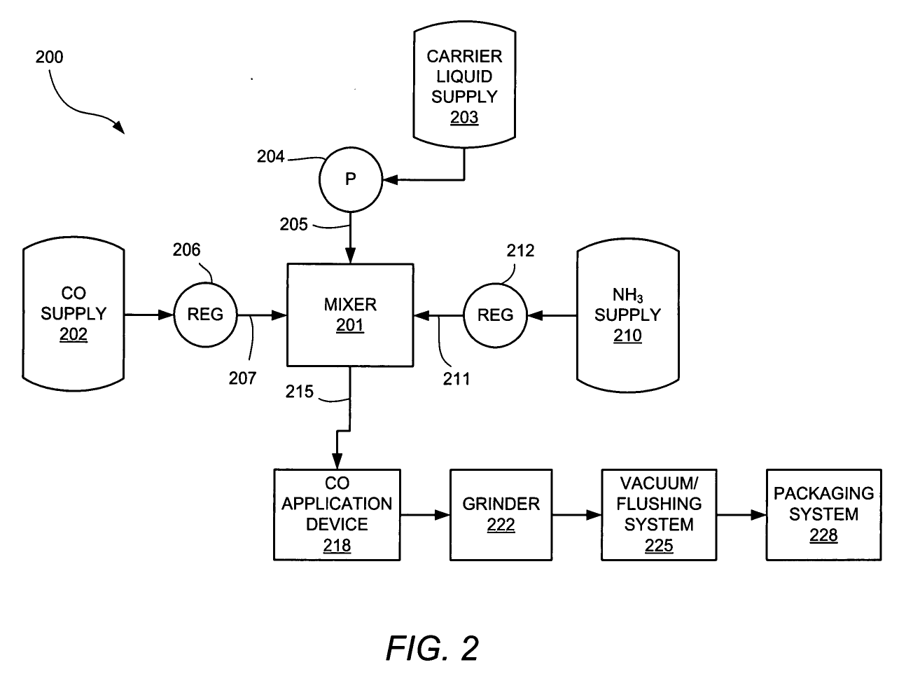

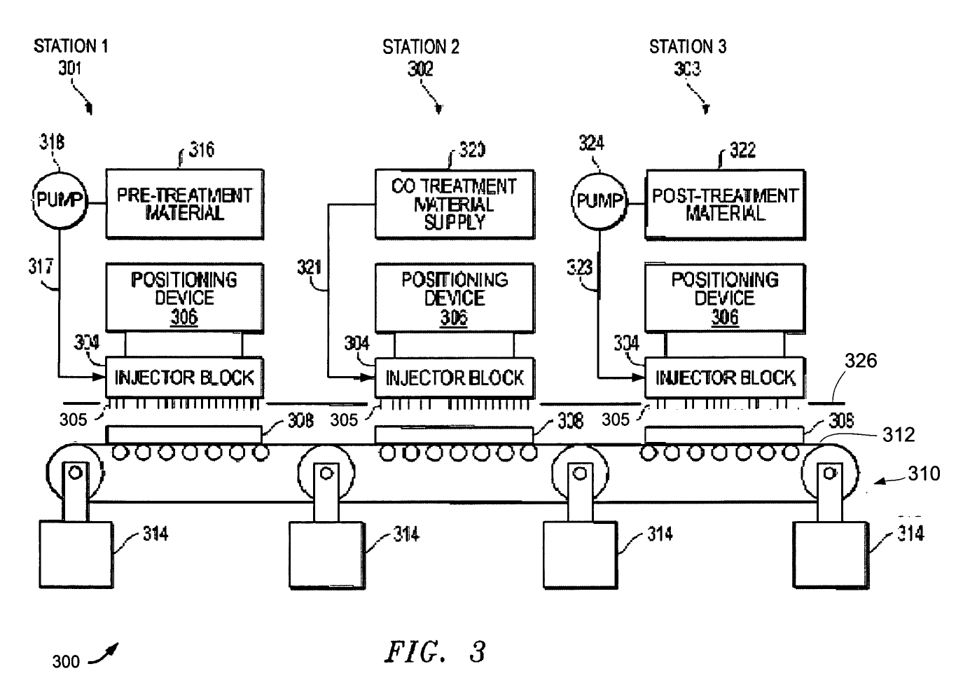

FIG. 1 will be used to describe various treatment methods within the scope of the invention. FIGS. 2 and 3 will be used to describe apparatus that may be used to treat meat products according to the invention and to describe further variations on the treatment methods shown in FIG. 1.

Referring to FIG. 1, a treatment process embodying the principles of the present invention may include first preparing a meat product as indicated at process block 101 to produce a meat product suitable for receiving a carbon monoxide treatment according to the present invention. The process shown in FIG. 1 also includes a pre-treatment as indicated at process block 102 prior to the application of treatment material containing carbon monoxide as shown at process block 103. FIG. 1 also shows a post-treatment at process block 104 after the application of carbon monoxide-bearing treatment material. After the post-treatment, the intermediate meat product resulting after the application of treatment material containing carbon monoxide is comminuted or further comminuted as indicated at process block 105. The process shown in FIG. 1 further includes a vacuum/flushing operation as indicated at process block 106 and then the treated meat product is packaged or frozen and packaged as indicated at process block 107.

It should be noted that some of the process steps shown in FIG. 1 are merely optional steps and are not necessary to the present invention. Fundamentally, the present invention includes applying the desired treatment material containing carbon monoxide to an initial meat product as indicated at process block 103 in FIG. 1, and then comminuting the resulting intermediate product as indicated at process block 105. Preparing a meat product as shown at process block 101 to place a meat product in condition for receiving the carbon monoxide-bearing treatment material may or may not be included in a process according to the invention. Some applications of the present invention may rely on receiving previously prepared meat products for application of the carbon monoxide-bearing treatment material, and may thus not include a preparation step. Also, the pre-treatment and post-treatment shown at process blocks 102 and 104, respectively, may or may not be employed in a process according to the present invention. Likewise, the vacuum/flushing step shown at process block 106 and the packaging/freezing step shown at process block 107 may not be used in a given implementation of the invention. For example, it is possible for a meat product to be treated with carbon monoxide-bearing treatment material as shown at process block 103 in FIG. 1, and then the resulting intermediate meat product immediately transferred to a bulk display case, fully or partially cooked, or incorporated into an end product.

Where a preparation step is included as shown at process block 101 in FIG. 1, the required preparation may be performed in any suitable manner. For example, preparation may include simply producing a whole, half, or quarter carcass from a slaughtered animal. Alternatively, a minimally processed product such as a whole, half, or quarter carcass may be trimmed and portions deboned to produce an initial meat product suitable for treatment according to the present invention. It should also be noted that an initial meat product that may form the feedstock for the present carbon monoxide treatment process may include simply trimmings or defatted trimmings and need not include large sections of meat.

Pre-treatments and post-treatments as shown at process blocks 102 and 104 may include numerous different types of treatments within the scope of the present invention. For example, one preferred post-treatment includes applying a pH decreasing material such as carbon dioxide gas or weak carbonic acid solution to the meat product. A pH decreasing material may also be applied to the meat product as a pre-treatment. Other pre or post-treatments may include adding pure water or brines, adding flavorings, or adjusting the temperature of the highly comminuted meat product. One preferred form of the invention includes a vacuum or flushing step as a post-treatment to remove excess treatment material containing carbon monoxide prior to the comminuting step shown at process block 105 in FIG. 1.

The comminuting step shown at process block 105 in FIG. 1 may include substantially any process that cuts the intermediate meat product down into smaller pieces. For example, where the initial meat product is a whole carcass or carcass section, the comminuting step shown at process block 105 in FIG. 1 may include first trimming the whole carcass or carcass section, deboning at least some portions of the material, and then subjecting the trimmings and/or deboned portions to further comminuting with a grinder or bowl chopper. In this example, the comminuting is actually performed in two discrete comminuting steps, the trimming, and then grinding/chopping. In yet another form of the invention, the initial meat product may be deboned meat which is then simply comminuted with a suitable device such as a grinder or bowl chopper for example.

The step of applying a vacuum or applying a flushing medium to the treated meat product as shown at process block 106 in FIG. 1 may be employed to remove excess carbon monoxide and/or ammonia-based pH increasing material and/or excess pre or post-treatment material from the treated meat product. For example, the treated meat product may be passed through a vacuum chamber or may be subjected to a stream of inert gas to remove excess treatment materials. The application of a vacuum or flushing gas may also be accompanied by an increase in temperature in the treated meat product to help release treatment materials from the meat.

Any suitable packaging or freezing and packaging may be employed as indicated at process block 107. For example, an initial meat product that has been treated with a treatment material containing carbon monoxide and then comminuted may be packaged in a traditional chub package. Alternatively, meat products that have been treated according to the invention may be packaged in any suitable modified atmosphere package. Where the product is frozen, it may first be formed into sheets, patties, or other suitable shapes and then frozen by a suitable freezing device. Alternatively, a meat product that has been treated according to the present invention may be frozen in the form of a sheet and then cut into chips which are then packaged in a suitable manner.

The treatment material containing carbon monoxide may be applied in substantially any suitable manner at process block 103 in FIG. 1. The treatment material containing carbon monoxide may be applied separately from any additional treatment material, or may be combined with pH modifying materials such as an ammonia-based pH increasing material or carbon dioxide-based pH decreasing material. The arrangement described below in connection with FIG. 2 provides an example treatment system in which the carbon monoxide and ammonia-based pH increasing material are combined with a carrier liquid and the resulting combination is then applied to the highly comminuted meat product. The arrangement described below in connection with FIG. 3 provides an example treatment system in which a treatment material containing carbon monoxide and an ammonia-based pH increasing material are applied separately to the initial meat product. In any application process within the scope of the invention, the carbon monoxide may be at least partly in gaseous form, or may be entirely in solution in a suitable carrier liquid. Similarly, any pH modifying material such as ammonia may be in gaseous form or in solution with water. In order to better control the effects of carbon monoxide application, some preferred forms of the invention apply carbon monoxide as a solute in solution with a carrier liquid such as water. Thus, the content of carbon monoxide in the carrier liquid may be at or below the solubility level of carbon monoxide in the carrier liquid at the temperature of the carrier liquid and at the application pressure, or some lower pressure to which the meat product will be subjected after application, such as atmospheric pressure for example. It should be noted that the presence of other materials dissolved in the carrier liquid may affect the amount of carbon monoxide that may be held in solution in the carrier liquid. Thus, the carbon monoxide content in the carrier liquid may vary depending upon the other materials to be held in solution in the carrier liquid.

The apparatus used to apply the treatment material containing carbon monoxide may vary depending upon the nature of the initial meat product to which the treatment material is applied. For deboned meat products, the treatment material containing carbon monoxide may be injected into the interior of the meat product using a suitable injection system with one or more injection needles/conduits. FIG. 3 below will be used to describe a suitable injection system. Pre-treatment materials and/or any post treatment materials employed in the particular process may also be injected into the interior of the meat product. Injection of treatment material may also be performed for meat products that include bones, provided that the injection apparatus is adapted to operate on meat products containing bones. Also, in addition to injecting the treatment material containing carbon monoxide, the treatment material may also be applied to the surface of the meat product being treated. This surface treatment will allow the treatment material to penetrate somewhat into the interior of the meat product. Particularly where the initial meat product is relatively thin, a surface application of treatment material containing carbon monoxide may be sufficient to treat the meat product. Surface treatments may be performed by spraying the treatment material onto the surface of the meat product or applying the treatment material through a sparging device.

Although some preferred forms of the invention utilize a carbon monoxide treatment material in which substantially all of the carbon monoxide is held in solution in a carrier liquid, some carbon monoxide in such a carbon monoxide treatment material may also be in the form of a gas suspended in the carrier liquid or as a gas atomizing/vaporizing the carrier liquid. Also, carbon monoxide may be applied as a gas. Whether the carbon monoxide is applied as a gas or in solution, or both in solution and in gas form, the carbon monoxide may be from any suitable source. For example, carbon monoxide may be supplied from a cylinder containing commercially produced pure carbon monoxide, or may be supplied from a food grade smoke generator. Regardless of the form or source of carbon monoxide applied to the highly comminuted meat product, the total carbon monoxide content in the carbon monoxide-bearing material applied as indicated at process block 103 in FIG. 1 should be low enough to avoid 100% carbon monoxide saturation in the treated meat product.

The desired carbon monoxide saturation level in the treated meat product may vary with the nature of the meat product being treated. In some meat products, such as those that have or will have added seasonings, carbon monoxide saturation may approach 100% saturation. In lightly seasoned or unseasoned meat products, such as plain ground beef for example, the desired carbon monoxide saturation according to the invention remains below 100% saturation, and preferably less than approximately 95%. Carbon monoxide saturation levels at approximately 70%, 60%, 50%, and 40% may also be used according to the invention. Again, depending upon the meat product being treated, the desired carbon monoxide saturation level may range from approximately 5% to 95% saturation. It should also be noted that the desired carbon monoxide saturation level in the treated meat product may vary with the amount of liquid added to the meat product. For example, a meat product treated according to the invention with added liquid content at 20% by weight with the meat may allow a higher desired carbon monoxide saturation level than at an added liquid content at 5% by weight with the meat. In any event, the carbon monoxide saturation level in the meat product treated according to the present invention should include a carbon monoxide saturation level or content low enough for the particular comminuted meat product to allow the meat product to brown properly in the course of cooking and to show visible signs of spoilage in the meat product when the product spoils due to bacterial activity.

The resulting pH in a comminuted meat product that has been treated with carbon monoxide and an ammonia-based pH increasing material according to the present invention may range from 5.6 to 8.0 or higher. Good results have been produced where the carbon monoxide/pH treated meat product had a final pH of 6.5 to 6.7 as well as where the treated product had a pH of 7.4. The pH of an ammonium hydroxide solution applied to the meat product may range from 8.5 to 11.6 or more. It should also be noted that the desired pH of an ammonium hydroxide solution comprising the ammonia-based pH increasing material applied at process block 103 in FIG. 1 may vary with the level of liquid added to the meat product in the present treatment process. For relatively low amounts of added liquid such as approximately 5% by weight with the meat, a pH of 11.6 or more in an ammonium hydroxide treatment material may be more appropriate. For higher added liquid content, say 15% to 20% for example, a pH of approximately 8.5 in an ammonium hydroxide treatment material may be more appropriate.

Where the ammonia-based pH increasing material comprises ammonium hydroxide solution and is applied separately before applying carbon monoxide, or where a pre-treatment application of water is employed in the process illustrated in FIG. 1, carbon monoxide may generally be added at a higher concentration than would otherwise be desirable. Also, it is generally desirable to apply carbon monoxide in gaseous form (either alone or mixed with other gasses) only after a liquid treatment material such as ammonium hydroxide, water, or brine has been applied to the comminuted meat. Where carbon monoxide is applied as a gas, the gases in a mixture with carbon monoxide may help the carbon monoxide to distribute better in the volume of the meat product. Although any suitable carbon monoxide concentration may be used, carbon monoxide concentration in preferred gaseous treatment material may be as low as one-tenth of a percent (0.1%).

Where treatment material containing carbon monoxide is applied in a gas mixture at process block 103 in FIG. 1, one preferred gas mixture includes oxygen in a suitable concentration. Oxygen may also be included with liquid treatment fluids in the form of suspended or dissolved oxygen gas or in the form of some other oxygenating material. Oxygen gas, dissolved oxygen, and any oxygenating material may each be referred to in this disclosure and the accompanying claims as an “oxygenating agent.” It is believed that the ammonia-based pH increasing material applied according to the invention interferes with the carbon monoxide binding with hemoglobin and myoglobin in the meat product so that the oxygen may compete better with the carbon monoxide to bind with these materials. Oxygen may be used in the present treatment process to tie up hemoglobin and myoglobin in the meat thereby reducing the amount of hemoglobin and myoglobin available to react with carbon monoxide to produce the carboxy forms of the materials. Making some of the hemoglobin and myoglobin unavailable for the carbon monoxide may effectively increase the carbon monoxide saturation in a meat product that already includes some carbon monoxide saturation or decrease the amount of carbon monoxide needed to produce a desired saturation level. It is believed that the materials applied according to the present invention to interfere with the binding of carbon monoxide with hemoglobin and myoglobin in the meat product allows the present carbon monoxide treated meat product to better show spoilage in the uncooked product and to produce a more natural appearance upon cooking.

Some preferred forms of the invention may perform the pre-treatment and/or post-treatment steps in rapid succession with the carbon monoxide and ammonia-based material treatment step shown at block 103 in FIG. 1. Other preferred forms of the invention, however, may include a delay between a pre-treatment and the carbon monoxide and ammonia-based material application and/or between the carbon monoxide and ammonia-based material application and any post-treatment. The delay may be from one second to one hundred and twenty (120) seconds or more. It will be appreciated that a delay between treatment steps according to the invention may be sufficiently long to require the meat product to be moved to a holding area for at least a portion of the delay period, before proceeding on to the next application or treatment step in the process shown in FIG. 1.

FIG. 2 shows a treatment system 200 that may be used to treat meat products with a treatment material containing carbon monoxide according to the present invention. System 200 includes a mixing device 201 (also referred to herein as a “mixer”) that receives carbon monoxide from a carbon monoxide supply 202 and receives a carrier liquid from a carrier liquid supply 203. A suitable carrier liquid may be water, brine, or ammonium hydroxide solution, for example, and may be pumped to mixing device 201 using a suitable pump 204 through suitable connecting line 205. The carbon monoxide is supplied preferably in the form of a gas, and thus a suitable pressure regulator 206 is provided in the connecting line 207 which connects carbon monoxide supply 202 to mixing device 201.

Treatment system 200 also includes an ammonia gas supply 210 that directs ammonia gas to mixing device 201 through connecting line 211. A suitable pressure regulator 212 is included in line 211 to control the flow of ammonia gas to mixing device 201. Mixing device 201 receives carbon monoxide gas, ammonia gas, and the carrier liquid, water for example, and mixes the materials or allows the materials to mix to produce a suitable treatment fluid containing the desired carbon monoxide content and ammonia content. This combined treatment fluid is directed through line 215 to be applied to an initial meat product.

A carbon monoxide application device (also referred to herein as a “CO application device”) 218 is included in treatment system 200 to receive the treatment fluid containing carbon monoxide and ammonia through line 215 and to apply the treatment fluid to an initial meat product supplied to, or contained in, the CO application device. The treatment system 200 shown in FIG. 2 also includes a grinder 222 connected to receive the treated meat product exiting CO application device 218. A vacuum/flushing system 225 receives the comminuted material exiting grinder 222 and the treated meat product is then directed to packaging system 228 where the meat product is packaged for distribution.

It will be appreciated that the diagrammatic representation of FIG. 2 does not show numerous components that may be included in treatment system 200. For example, connecting lines 205, 207, and 211 may include numerous fittings and components such as check valves or filters. Vacuum/flushing system 225 and packaging system 228 may in fact each comprise a complicated system, the details of which are well known in the field of food processing. Details on these types of components are unnecessary for an understanding of the present invention, and thus these details are omitted from FIG. 2.

Mixer 201 may be any suitable device or combination of devices for receiving the carrier liquid, carbon monoxide, and ammonia gas and mixing the materials together to produce the desired carbon monoxide/ammonia-based material treatment fluid. For example, mixer 201 may be a sparging device or multiple sparging devices for adding the carbon monoxide gas and ammonia gas to the carrier liquid. Alternatively, mixer 201 may include one or more devices in which the carbon monoxide and ammonia-base treatment material are added to the carrier liquid through a permeable or semipermeable membrane as the carrier liquid flows through the device or devices. In any case, where the carbon monoxide and ammonia are added to the carrier liquid separately, the ammonia is preferably applied to the carrier liquid first and then the carbon monoxide. This may help reduce the carbon monoxide gas in the resulting treatment material which may be advantageous for some implementations of the invention.

FIG. 2 does not show any device for supplying an initial meat product to CO application device 218, however, some device may be included in the system for supplying the initial meat product to the CO application device, or for pre-treating the initial meat product or conducting processing operations to produce the initial meat product from a slaughtered animal carcass. One form of treatment system 200 may be designed to apply the treatment material containing carbon monoxide to an initial meat product made up of relatively large chunks of substantially boneless meat pieces over approximately two inches along their shortest dimension (minor dimension). In this implementation, treatment system 200 may include a suitable screw-type or other type of pump (not shown) for driving the initial meat product to CO application device 218, which may include either a sparging device or an injection device as will be described further below. Where a pump is used to feed the initial meat product to CO application device 218, the pump may be any suitable pumping device such as a screw-type pump or a positive displacement pump. The pump may not only supply the driving force for driving the initial meat product through the CO application device but also through grinder 222, vacuum/flushing system 225, and packaging system 228. However, additional pumps may be required to drive the meat product through all components of a system such as system 200 in FIG. 2. Other forms of treatment system 200 may be designed to apply the desired treatment material containing carbon monoxide to an initial meat product comprising larger cuts of meat or sections of animal carcass. These implementations of treatment system 200 may include a suitable conveyor system for feeding the initial meat product to the CO application device 218, which may include an injection device for injecting the treatment material containing carbon monoxide into the interior of the initial meat product and perhaps applying the treatment material to the surface of the meat as well.

CO application device 218 shown in FIG. 2 may comprise any suitable device for applying the treatment material containing carbon monoxide to the initial meat product. For example, in implementations in which the initial meat product is made up of relatively large chunks of meat or elongated narrow meat pieces, the annular sparging device shown at reference numeral 15 in U.S. patent application publication No. 2003-0017252-A1 may be used to apply the desired treatment material to the comminuted meat. Alternatively, a sparging device such as that shown at reference numeral 40 in U.S. patent publication No. 2003-0017252-A1, may be used to receive the carbon monoxide-bearing treatment material and apply it to the meat product. This U.S. patent application publication is incorporated herein in its entirely by this reference. Any sparging device that may be used to sparge the desired treatment material into the initial meat product may allow the treatment material to reach the meat product through a permeable metal or metal membrane. U.S. patent publication No. 2003-0017252-A1 discloses permeable metal arrangements for sparging a treatment material into a meat product.

In forms of the invention intended to treat large initial meat products having a smallest dimension well over two inches, CO application device 218 preferably includes an injection system having one or more injection conduits to inject the treatment material containing carbon monoxide into the interior of the meat product in addition to perhaps applying the treatment material to the surface of the initial meat product. Further details of a suitable injection device will be described below with reference to FIG. 3. The present invention is, however, not limited to any particular type of treatment material injection device for applying the carbon monoxide-bearing treatment material.

The grinder 222 shown in FIG. 2 receives the intermediate meat product produced by application of the carbon monoxide-bearing treatment material at device 218 and comminutes or further comminutes the intermediate meat product. Although the example system 200 shown in FIG. 2 indicates that grinder 222 receives the intermediate meat product directly from CO application device 218, other implementations of the present invention may include intervening equipment or processing stations between the CO application device and the grinder. For example, where the meat product treated at CO application device 218 is a substantially whole carcass or section of a whole carcass, the whole or section of carcass is preferably trimmed to remove most bones prior to comminuting the resulting deboned meat in grinder 222. Some grinders, however, may be adapted to separate bone and other hard materials from meat, and thus, the meat product treated at CO application device 218 need not be carefully deboned prior to comminution according to the present invention.

There may be a benefit to allowing a certain minimum amount of time to elapse between the application of carbon monoxide-bearing treatment material according to the invention and the time that the treated meat product is comminuted at grinder 222. It is believed that the storage time allows the added materials to better distribute and equilibrate through the meat product. To accommodate a suitable storage time there may be a storage facility interposed between CO application device 218 and grinder 222. Any storage of the carbon monoxide treated meat is preferably done under a controlled atmosphere at a suitable storage temperature.

The example treatment system 200 shown in FIG. 2 includes vacuum/flushing system 225 located to process comminuted meat product after grinder 222. System 225 may include a vacuum chamber in which the comminuted meat is subjected to a vacuum (any pressure less than atmospheric pressure) and/or may include a device for directing a flushing gas or gas mixture over the surface of the comminuted meat. System 225 may alternatively comprise a vessel in which the comminuted meat is agitated while applying a vacuum or a flushing gas/gas mixture. System 225 may also include a heating arrangement for increasing the temperature of the comminuted meat product to help release any excess treatment materials including carbon monoxide and, in this example system, ammonia gas. Alternative systems within the scope of the present invention may include a vacuum/flushing system such as system 225 in position to process the intermediate meat product before being comminuted or further comminuted in grinder 222.

Packaging system 228 may be any packaging system suitable for the carbon monoxide-treated, comminuted meat product produced according to the present invention. For example, packaging system 228 may be a chub packaging device, or a modified atmosphere packaging device. It is also possible to package the comminuted meat product in standard trays without any modified atmosphere.

FIG. 3 provides a diagrammatic illustration of an injection system 300 that may be employed as CO application device 218 shown in FIG. 2. Injection system 300 shown in FIG. 3 includes three separate stations for injecting fluids into a meat product. A first station is shown generally at reference numeral 301, a second station is shown at 302, and a third station is shown at 303. Each station includes an injector block 304 preferably supporting a large number of spaced apart injection conduits 305. Injector block 304 not only serves as a support for the injection conduits 305 but also may serve as a manifold for distributing the desired material from an injector block inlet to the various injection conduits associated with the respective injector block. Each injector block 304 is shown operatively connected with a respective positioning device 306. Each respective positioning device 306 is adapted to move the respective injector block 304, and thus the respective injection conduits 305, relative to a meat product to be treated. In particular, once a meat product such as a product shown at 308 in FIG. 3 is in position for a respective station, the respective positioning device 306 may push the injector block 304 downwardly so that the associated injection conduits 305 penetrate into the volume of the meat product to a desired injection position. From this injection position, the desired treatment material may be injected into the volume of the meat product 308 through the injection conduits 305. Once a desired volume of treatment material has been injected, the respective positioning device 306 may raise its associated injector block 304 to withdraw the respective injection conduits 305 from the meat product 308.

Injection system 300 shown in FIG. 3 includes a meat product support and positioning arrangement shown generally at reference numeral 310. Support and positioning arrangement 310 includes a conveyor 312 for conveying meat products 308 into the system, from station to station in the system, and finally out of the system to a subsequent processing stage such as a vacuum/flushing system or a packaging system as shown in FIG. 2, or a surface treatment arrangement (not shown). In addition to or in lieu of the positioning device 306 associated with each station, injection system 300 may include a meat product support and positioning arrangement including actuating devices 314 that may be operated to move the meat product support and thus the meat product 308 in relation to the various injector blocks 304 and injection conduits 305.

Each treatment station 301, 302, and 303 shown in FIG. 3 is associated with a separate treatment material supply connected through a suitable conduit to the respective injector block 304. In particular, FIG. 3 shows a pre-treatment material supply 316 connected to the injector block 304 associated with station 301, through connecting conduit 317. A pump 318 is shown in the conduit 317 for supplying the pre-treatment material at a suitable injection pressure. A CO treatment material supply 320 is shown associated with the second station 302 and connected through a suitable conduit 321 to supply the CO treatment material to the respective injector block 304 at a suitable injection pressure. This CO treatment material supply 320 may, for example, correspond to the mixer 201 and associated material supplies 202, 203, and 210 shown in FIG. 2. Finally, a post-treatment material supply 322 is shown associated with the third station 303 together with connecting conduit 323 and pump 324 to provide the material under a suitable injection pressure. It will be noted that although injection system 300 is suitable for use as CO application device 218 shown in FIG. 2, the pre-treatment material and post-treatment supply arrangements corresponding to components 316 and 322 in FIG. 3 are not shown in FIG. 2.

The injection pressures suitable for use in injecting a treatment material containing carbon monoxide, pre-treatment material, and post-treatment material according to the present invention generally coincide with those pressures used for injecting brines into meat products as known in the prior art. The injection pressures may vary depending upon the temperature and nature of the meat being treated, the size of injection conduits employed, the exit openings in the injection conduits, and the amount of material to be added to the meat product. Where the initial meat product is made up of beef steaks at 35 degrees Fahrenheit, for example, 2.5 bars is a suitable pressure for injecting material to produce a content of added solution at 10% by weight with the meat, and 3.5 bars is a suitable pressure for injecting material to produce a content of added solution at 20% by weight with the meat. Lower injection pressures are also possible within the scope of the invention, depending upon the nature of the injection device.

It will be appreciated that the meat product 308 being treated in injection system 300 shown FIG. 3 may need to be refrigerated in the injection system to maintain suitable temperature conditions in the meat product. FIG. 3 shows an insulating barrier 326 above the meat product supporting arrangement 310 and below the injector blocks 304. Injection conduits 305 traverse the plane of the insulating barrier 326 through suitable openings to reach the meat products 308. The insulating barrier material may simply terminate in the area of each injector block 304 or may include openings through which the individual injection conduits may extend to reach the meat products 308 to be treated. Injection system 300 may also have associated with it a suitable refrigeration arrangement for cooling at least the area between the barrier 326 and the meat product support surface.

An injection conduit 305 used to inject the carbon monoxide-bearing treatment material and other materials into the volume of a meat product according to the present invention may include any suitable conduit or needle suitable for penetrating the surface of the meat product so that the desired treatment material may be injected into the volume of the meat product. Preferred forms of the invention utilize elongated injection conduits with a sharp distal end for piercing the surface of the meat product and preferably a number of injection passages spaced apart along the length of the injection conduit that penetrates into the interior of the meat product. Rather than discrete injection openings, one or more areas of porous and permeable material such as a plastic, ceramic, or cintered metal may be included along the length of the injection conduit 305 to provide one or more areas through which the treatment material may flow from the conduit into the volume of the meat product being treated. Some forms of the invention may include injection conduits that include porous and permeable material along their entire length with an axial passage extending there through and with a solid distal portion to provide a sharp tip. Still other forms of the invention may include injection conduits of different lengths and with injection flow passages positioned at different penetration depths in the volume of the meat product. These and any other suitable arrangement of injection conduits may be used to distribute the treatment material containing carbon monoxide and other liquids or fluids into the volume of the meat product to ensure the desired carbon monoxide treatment and distribution according to the present invention.

The present invention encompasses numerous variations on the injection system shown in FIG. 3. For example, a suitable injection system may include only a single injection station rather than the three separate stations shown in FIG. 3. Even in a single station embodiment, different material supplies may be connected to a single injector block (such as injector block 304 in FIG. 3) so that different materials including the treatment material containing carbon monoxide and any pre-treatment or post-treatment materials may be injected into the meat products through the single injector block and associated injection conduits. Furthermore, it is possible according to the present invention to use only a limited number of injection conduits 305 or even only a single injection conduit. When using a limited number of injection conduits 305 or a single injection conduit for a relatively large meat product, each injection conduit is preferably inserted at one point to inject the desired material and then withdrawn and inserted at another point for injecting the treatment material at that point. This process may be repeated at different locations across the meat product to provide the desired even carbon monoxide distribution throughout the volume of the meat product.

In preferred forms of the invention, the different injection points for the CO treatment material and for the pre-treatment and post-treatment materials are spaced apart on approximately one-eighth (⅛) of an inch to one (1) inch centers across the meat product being treated. Generally, the closer the spacing the better, subject to physical limitations of the injection conduits and the impact of the injection conduits on the meat. Where injection conduits are inserted at different points to provide the desired injection coverage, the different insertion points are also spaced apart between one-eighth-(⅛) of an inch to one (1) inch. Any suitable needle or injection conduit may be used in the present invention. The outer diameter of preferred needles or injection conduits may range from 2 to 6 millimeters or more. Also, where the meat product being treated may include bones, the injection system may include an arrangement for enabling an injection conduit 305 to be axially displaced in the event it is pressed into a bone in the meat product.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be closed or semi-closed transitional phrases, as set forth, with respect to claims, in the United States Patent Office Manual of Patent Examining Procedures (Eighth Edition, August 2001 as revised May 2004), Section 2111.03.

Use of ordinal terms such as “first,” “second,” “third,” etc., in the claims to modify a claim element does not by itself connote any priority, precedence, or order of one claim element over another or the temporal order in which acts of a method are performed. Such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the following claims.

1. A method including:
(a) applying a treatment material containing carbon monoxide to an initial meat product to produce an intermediate meat product;
(b) comminuting the intermediate meat product.

2. The method of claim 1 wherein comminuting the intermediate meat product includes reducing the size of the intermediate meat product to pieces having a major dimension less than approximately two inches.

3. The method of claim 2 wherein comminuting the intermediate meat product includes passing the intermediate meat product through a meat grinder.

4. The method of claim 1 wherein applying the treatment material to the initial meat product includes injecting the treatment material into an interior of the initial meat product.

5. The method of claim 1 further including applying a pH modifying material to the initial meat product prior to applying the treatment material.

6. The method of claim 1 further including applying a pH modifying material to the initial meat product before applying the treatment material.

7. The method of claim 1 wherein the treatment fluid includes a pH modifying material.

8. The method of claim 1 wherein the initial meat product includes a whole carcass portion and wherein comminuting the intermediate meat product includes trimming the whole carcass portion.

9. A method including:
(a) applying an ammonia-based pH increasing material to an initial meat product;
(b) applying carbon monoxide to the initial meat product;
(c) comminuting the initial meat product after applying the ammonia-based pH increasing material and carbon monoxide.

10. The method of claim 9 wherein comminuting the initial meat product includes reducing the size of the initial meat product to pieces having a major dimension less than approximately two inches.

11. The method of claim 10 wherein comminuting the initial meat product includes passing the initial meat product through a meat grinder.

12. The method of claim 9 wherein applying carbon monoxide to the initial meat product includes injecting a treatment material containing carbon monoxide into an interior of the initial meat product.

13. The method of claim 9 wherein applying the ammonia-based pH increasing material to the initial meat product includes injecting the ammonia-based pH increasing material into an interior of the initial meat product.

14. The method of claim 9 wherein the ammonia-based pH increasing material includes carbon monoxide and wherein the ammonia-based pH increasing material containing carbon monoxide is applied to the initial meat product by injection into the interior of the initial meat product.

15. The method of claim 9 wherein the initial meat product includes a whole carcass portion and wherein comminuting the initial meat product includes trimming the whole carcass portion.

16. A method including:
(a) injecting an ammonia-based pH increasing material into an initial meat product;
(b) injecting carbon monoxide into the initial meat product; and
(c) comminuting the initial meat product after injecting the ammonia-based pH increasing material and carbon monoxide.

17. The method of claim 16 wherein the ammonia-based pH increasing material and carbon monoxide are simultaneously injected into the initial meat product.

18. The method of claim 16 wherein the ammonia-based pH increasing material is injected into the initial meat product prior to injecting the carbon monoxide.

19. The method of claim 16 wherein a liquid is injected into the initial meat product prior to injecting carbon monoxide.

20. The method of claim 16 wherein the initial meat product is a whole carcass portion and wherein comminuting the initial meat product after injecting the ammonia-based pH increasing material and carbon monoxide includes first trimming the whole carcass portion to produce a trimmed product and then comminuting the trimmed product.
